(19) United States
(12) Patent Application Publication
(10) Pub. No.: US 2015/0254449 A1
(43) Pub. Date: Sep. 10, 2015

(54) Coordinated Passcode Challenge for Securing a Device

(71) Applicant: Google Inc., Mountain View, CA (US)

(72) Inventors: Benjamin David Poiesz, Santa Clara, CA (US); Andrew Abramson, Sunnyvale, CA (US)

(73) Assignee: Google Inc., Mountain View, CA (US)

(21) Appl. No.: 14/197,515

(22) Filed: Mar. 5, 2014

(51) Int. Cl. G06F 21/40; G06F 21/50

(52) U.S. Cl. CPC G06F 21/40; G06F 21/50

(57) ABSTRACT

Described is a device that secures low level software on the device such as a boot loader. In addition, the device may coordinate a passcode challenge between a boot module, which may be provided by a first manufacturer, and an operating system of the device, which may be provided by a second distinct manufacturer. By coordinating passcodes challenges, a user may not be required to establish and/or remember two separate passcodes for securing the device.

### BACKGROUND

A mobile device often has the ability to protect data stored on the device when it is lost or stolen. For example, the mobile device may have an access control such as a password lock or other technique for securing the device. A common method of bypassing standard password challenge technologies is to reboot the device into low level software and wipe and/or reset the device. While this reset may wipe and thus protect the personal data, the increasing value of mobile devices creates the need to protect the device itself and to discourage theft. In addition, a low level bootloader, operating system, and hardware may all have different manufacturers. Accordingly, providing an efficient and convenient method of securing a mobile device may be problematic.

### BRIEF SUMMARY

In an implementation, described is a device including a processor, the processor may be configured to establish, by an operating system of the device, a first passcode challenge for accessing the device, and receive, by a boot module of the device and prior to loading the operating system, an indication to reset the device. The processor may also be configured to access, by the boot module, the operating system to coordinate a second passcode challenge with the first passcode challenge, provide, by the boot module, the coordinated second passcode challenge for resetting the device to factory settings, and reset the device upon a verification of a response to the second passcode challenge.

In an implementation, described is a method including establishing, by an operating system of the device, a first passcode challenge for accessing the device, and receiving, by a boot module of the device and prior to loading the operating system, an indication to reset the device. The method may also include accessing, by the boot module, the operating system to coordinate a second passcode challenge with the first passcode challenge, providing, by the boot module, the coordinated second passcode challenge for resetting the device to factory settings, and resetting the device upon a verification of a response to the second passcode challenge.

In an implementation, described is a device including a processor, the processor may be configured to establish, by an operating system of the device, a first authentication challenge for accessing the device, and receive, by a boot module of the device and prior to loading the operating system, an indication to reset the device. The processor may also be configured to access, by the boot module, the operating system to coordinate a second authentication challenge with the first authentication challenge, provide, by the boot module, the coordinated second authentication challenge for resetting the device to factory settings, and reset the device upon a verification of a response to the second authentication challenge.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 illustrates a block diagram of a device according to an implementation of the disclosed subject matter.

FIG. 2 illustrates a network arrangement according to an implementation of the disclosed subject matter.

FIG. 3 illustrates a flow diagram of coordinating a boot module passcode challenge according to an implementation of the disclosed subject matter.

FIG. 4 illustrates an example flow chart for resetting the device to factory settings according to an implementation of the disclosed subject matter.

FIG. 5 illustrates an example software hierarchy installed on the device according to an implementation of the disclosed subject matter.

### DETAILED DESCRIPTION

Described is a device and method that provides a passcode challenge coordinated between a boot module (which may be provided by an original equipment manufacturer) and the operating system (which may be provided by an operating system manufacturer). By coordinating passcodes challenges, a user is not required to establish and/or remember two separate passcodes for securing the device.

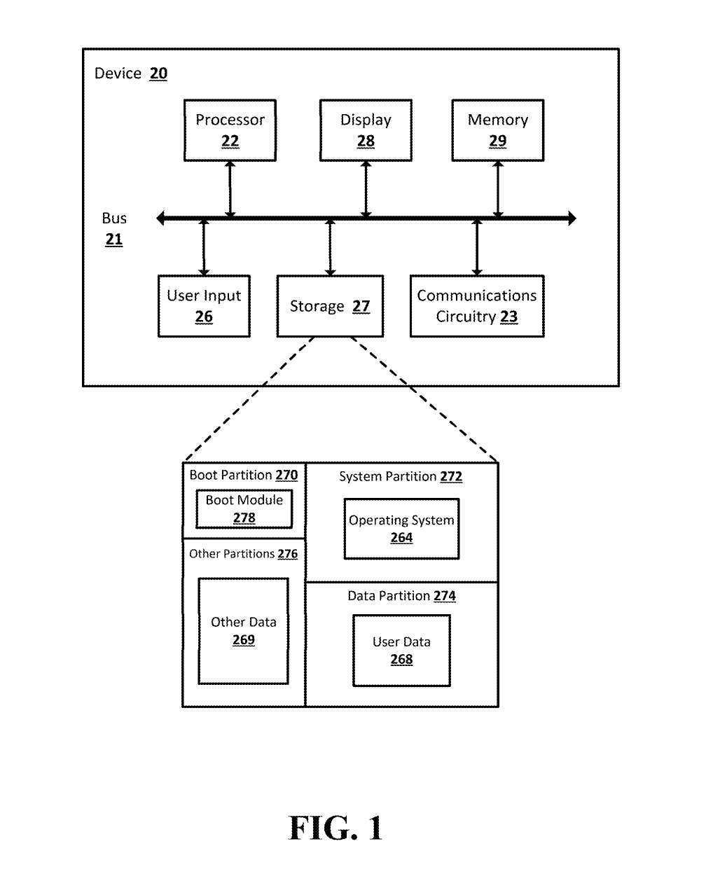

FIG. 1 illustrates a block diagram of a device according to an implementation of the disclosed subject matter. The device 20 may include, or be part of, a variety of types of computing devices such as a handheld device including a mobile phone or “smartphone,” tablet computer, laptop, netbook, desktop, personal digital assistant (“PDA”), media device, set-top box, television, and/or watch, among others. The device 20 may include a bus 21, processor 22, user input 26, display 28, communications circuitry 23, storage 27, and memory 29. The bus 21 may provide a data transfer path for transferring between components of the device 20. The display 28 may provide visual output and may include a touch-sensitive screen. The user input 26 may allow a user to interact with the device 20. For example, the user input 26 may include buttons, a keypad, a touch screen, microphone, and the like.

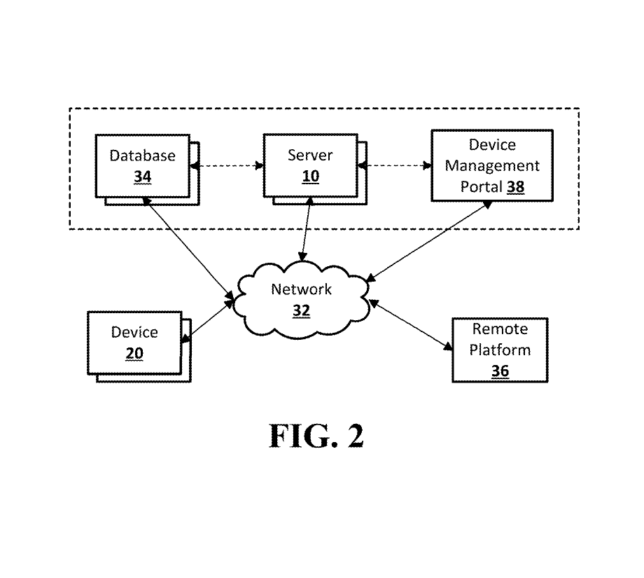

The communications circuitry 23 may include circuitry (e.g. a radio) for wireless communications for short-range and/or long range communication. For example, the wireless communication circuitry may include circuitry for connecting to a network (e.g. network 32 as shown in FIG. 2). The network may include a cellular network utilizing suitable protocols such as GSM and CDMA based wireless protocols. The communication circuitry 23 may also include Wi-Fi enabling circuitry for one of the 802.11 standards and circuitry for any other wireless network protocols. For example, the mobile device (e.g. a tablet) may not necessary include cellular calling capabilities, but may include Wi-Fi enabling circuitry for connecting to a network such as the internet. Communications circuitry 23 may also include circuitry that enables the device 20 to be electrically coupled to another device (e.g. a computer or an accessory device) and communicate with that other device.

The device 20 may be battery-operated and portable so as to allow a user to communicate with others, listen to music, play games or video, record video, take pictures, or control other devices. The device 20 may be relatively compact which enables a user to easily manipulate the device's position, orientation, and movement. Accordingly, the device 20 may provide techniques of sensing such changes in position, orientation, and movement to enable a user to interface with or control the device 20 by affecting such changes. Further, the device 20 may include a vibration source, under the control of processor 22, for example, to facilitate sending motion, vibration, and/or movement information to a user related to an operation of the device 20.

The memory 29 may include any suitable type of memory such as cache, Random-Access Memory (RAM), Read-Only Memory (ROM) including erasable programmable read only memory (EPROM), electrically erasable programmable read-only memory (EEPROM), Flash ROM, and the like. The RAM may store instructions loaded during a startup of the device.

The storage 27 may include any suitable types of storage. The storage 27 may store content (e.g. email message, multimedia, photos, etc.), software including an operating system and other suitable data. The storage 27 may include a hard-drive, solid state drive, flash drive, and the like. In addition, the storage 27 may be integral with the device 20 or may be separate and accessed through an interface to receive a memory card, USB drive, and the like. As shown, the storage 27 may include one or more partitions.

The partitions may include a boot partition 270, a system partition 272, a data partition 274, and one or more other partitions 276. The boot partition 270 may include modules reserved for boot functions such as a boot module 278. The system partition 272 may include an operating system 264. The operating system 264 may include, for example, a collection of software modules that manage device resources and provides common services for applications. The device may include one or more operating systems, but in some instances, may include only one operating system. Typically, the system partition 272 may be administered as read-only (in most circumstances) for security reasons and to prevent corruption of important system modules.

The data partition 274 may store user data 268. This user data 268 may be modified often and may be completely reformatted, deleted, wiped, reset, and the like without removing the operating system 264. Accordingly, the data partition 274 may be administered as read-write for a typical user. User data 268 may include content that is stored on the device such as email messages, multimedia, photos, etc. and applications that the user has installed on the device. For example, in an implementation, the user data may include substantially all data stored on the device not including an operating system 264 and system modules. In another example, user data 268 may include data stored on the device by the user. In other words, user data 268 may not include the operating system 264, which may be provided by a platform provider, and system modules such as the boot module 278, which may be provided by a manufacturer (e.g. OEM) of the device. In yet another example, user data 268 may include data stored on portions or partitions of the storage intended be accessible and/or writeable (e.g. read-write) by a user.

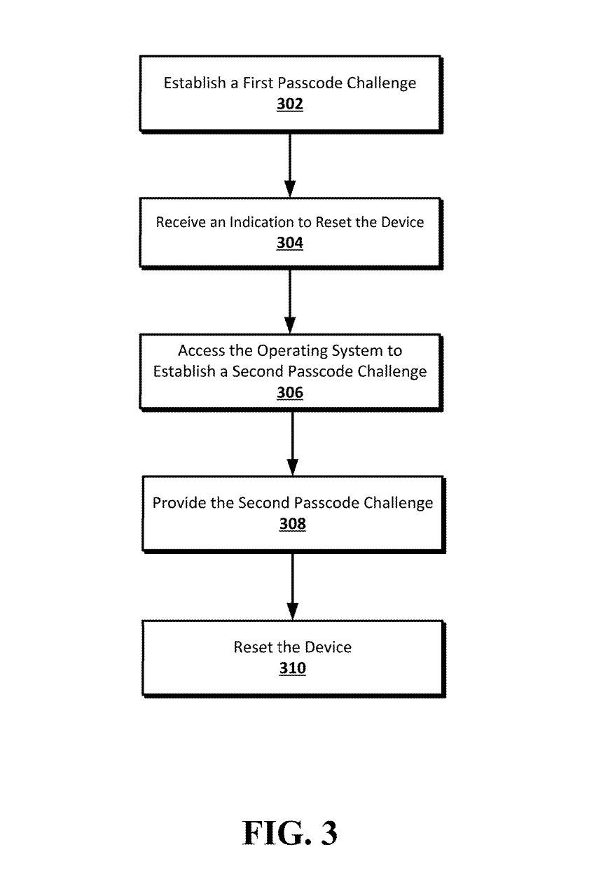

Other partitions 276 may include partitions for other data 269. For example, a partition reserved for system recovery may store a backup version of an operating system during an upgrade. Other data 269 may include other forms of data such as temporary data, and recovery data, and the like. The system partition 272 and the other partitions 276 may or not be accessible by a user. For example, a user may not be able to read or write on these partitions if it is not intended to be accessible to a user. It should be noted that the partitions shown in FIG. 3 are just examples and other partitions and/or configurations may also be used. For example, an operating system 264 and user data 268 may be stored on the same partition. In another example, the boot module 278 may be stored on an additional storage and/or memory that is distinct from the storage including, for example, an operating system 264 and/or user data 268.

An operating system 264 may include a platform and/or other software components as known to a person of ordinary skill in the art that may be distinct from a boot module 278 of the device. The operating system 264 may be provided and/or installed on the device by a platform provider and/or an operating system manufacturer. An original equipment manufacturer, or OEM, may manufacture and/or provide the device. Accordingly, an OEM may install low level software and/or firmware on the boot partition 270 such as the boot module 278, which may include a boot loader. For example, OEMs may provide different versions of a device (e.g. smartphone) that may be specific to a particular cellular provider. For example, the device may be configured specifically for a GSM or CDMA technologies based on the carrier.

The device 20 may be associated with one or more user accounts. These accounts may include a single account such as a primary user account, and/or other types of accounts such as an administrative user type account. These accounts may be defined during an initialization of the device (e.g. upon purchasing the device, or upon configuring the device with a carrier such as a cellular service provider), or at another point in time. The user account information may be stored on the device or in a remote location such as on the server 10, which may include the device management portal 38. In an implementation, an authorized user of the device may be determined based on the user account associated with the user. For example, an authorized user may be determined based on the device requiring a primary user account. As mobile device are often viewed as “personal,” the device may be limited to a single authorized user at a time. An authorized user may be authorized to perform device management functions such as configuring settings of the device. The functions may be performed directly on the device and/or through a central website such as the device management portal 38 (as shown in FIG. 2). Typically, in order to perform device management functions remotely, a user must first be authenticated such as by logging into the user account. A user may access the device management portal 38 through a website or a specific application for accessing the portal.

FIG. 2 illustrates an example network arrangement according to an implementation of the disclosed subject matter. The network 32 may be a local network, wide-area network (including the Internet), or any other suitable communication network or networks, and may be implemented on any suitable platform including wired and/or wireless networks. The network 32 may be part of a public and/or a private network any may also include one or more gateways, which facilitate the transfer of data between devices using different protocols. Further, the network 32 may include secure links and/or unsecure links. Additionally, the network 32 may include network infrastructure provided by multiple parties, such as a host network and one or more partner networks (e.g. roaming partners).

The device 20 may communicate with other devices 20, servers 10, databases 34, and a device management portal 38 via the network 32. The database 34 may be part of or coupled to the server 10. The server 10 may be directly accessible by the device 20, or one or more other devices 20 may provide intermediary access to a server 10. The server 10 may also be part of or coupled to a device management portal 38. The device 20 and/or server 10 may access a remote platform 36 such as cloud computing arrangement or service. The remote platform 36 may also include one or more servers 10, databases 34, and the device management portal 38. The term server may be used herein and may include a single server or a system of servers including one or more databases 34 and the device management portal 38. For example, a server 10 may include one or more servers responsible for managing devices and user accounts and interfacing with a user through the device management portal 38.

FIG. 3 illustrates a flow diagram of coordinating a boot module passcode challenge according to an implementation of the disclosed subject matter. In 302, the device may establish a first passcode challenge. An operating system of the device may establish a passcode challenge in order to secure the device. The first passcode challenge may secure the device at an operating system level. For example, the first passcode challenge may secure certain functionality provided by the operating system components such as accessing certain communication functions (e.g. email, text messages, etc.) and/or functionality provided by applications (e.g. web browsing, playing multimedia, etc.).

When establishing a first passcode challenge, an operating system may initialize and/or provide instructions to the user for providing a lockscreen on the device. The lockscreen may regulate access to a device by requiring that the user perform a certain action such as entering a passcode. In addition, a passcode challenge may be established and/or administered for functionality beyond unlocking the device such as accessing certain applications. The lockscreen may be administered by the device at various times and may be established for one or more users (e.g. user account and/or administrator account).

In 304, the boot module may receive an indication to reset the device. As described above, the boot module (e.g. boot loader) may be responsible for providing an initial set of operations for the device (e.g. from a ROM). The boot module may receive the indication to reset the device before, during, and/or after a boot sequence of the device. For example, during a boot sequence, the user may provide an interrupt command, and in response, the boot module may provide a menu, which may include an option to rest the device. For instance, the menu may include an option to perform a “factory reset” or similar operation and this indication may be received prior to loading an operating system of the device. In response to receiving an indication to reset the device, the boot module may provide a second passcode challenge for verification purposes prior to resetting the device.

In 306, the boot module may access the operating system to establish a second passcode challenge. The boot module may access the operating system to coordinate a second passcode challenge with the first passcode challenge. Accessing the operating system to coordinate the second passcode challenge with the first passcode challenge may include the boot module synchronizing the second passcode challenge with the first passcode challenge. For example, an alphanumeric PIN code (e.g. a 4 digit numeric PIN) may be synchronized between the first and second passcode challenges. Accordingly, the user may enter the same PIN code in response to a second passcode challenge (e.g. provided by the boot module) to reset the device as would be required to access the device (e.g. a lock screen provided by the operating system). Typically the passcode includes an alphanumeric PIN, but other authentication techniques such as biometrics may also be synchronized. In order to synchronize passcodes, the boot module may access an application programing interface (API) administered by the operating system. This allows the device to provide a uniform method for various boot modules, which may be provided by various vendors (e.g. OEMs), to access and/or coordinate a second passcode challenge with the operating system. In another example, the boot module may access a storage utilized by the operating system. For instance, the device may administer access permissions through the operating system or lower levels of software and/or firmware and the boot module may be granted access to a particular secured storage containing the first passcode. It should be noted that the device may establish the second passcode challenge at various times. For example, the boot module may establish the second passcode challenge when a first passcode challenge (e.g. lockscreen provided by the operating system) is determined. In another example, the boot module may establish the second passcode challenge upon receiving an indication to reset the device.

In 308, the boot module may provide the coordinated second passcode challenge for resetting the device. This challenge may be required as an authentication procedure before resetting the device from the boot loader. In 310, the boot module and/or operating system may reset the device upon a verification of a response to the second passcode challenge. The reset may include resetting the device to factory settings. For example, the default settings and/or configuration the device as provided by the OEM. Resetting the device may also include performing other functions such as reformatting, wiping, deleting, and/or “bricking” the device. For example, a resetting the device may include wiping one or more storage partitions on the device. For instance, resetting the device may include wiping a data partition (e.g. data associated with a user) while the system partition remains intact. Such a reset may be performed, for example, in instances where the device will be associated with a new and/or different user.

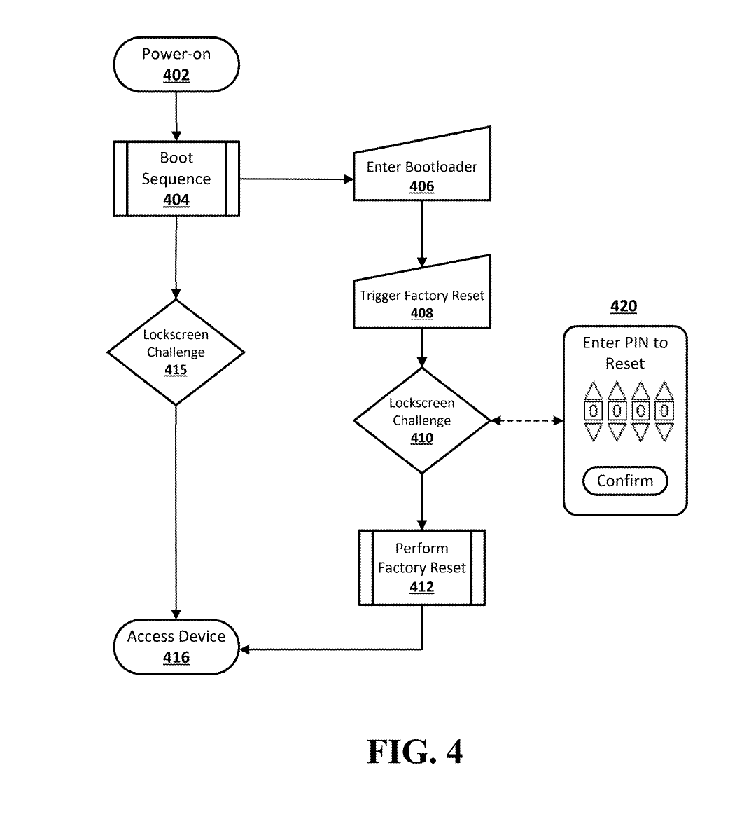

FIG. 4 illustrates an example flow chart for performing a factory reset on a device according to an implementation of the disclosed subject matter. As shown, once a device is powered-on in 402, the device may enter a boot sequence 404. As described above, a user may provide an interrupt in order to enter the bootloader 406. From the bootloader 406, the user may provide an indication (e.g. selection of a menu option) to trigger a factor reset of the device 408. In response to the indication to reset the device, the boot module (e.g. bootloader) may provide a lockscreen challenge 410. As shown in 420, the lockscreen challenge may require the user to enter a PIN for verification. Once the user has been verified by the lockscreen challenge in 410, the boot module may perform a factory reset 412. In addition, as shown, the operating system may also provide a lockscreen challenge 415 after the boot sequence 404 is complete in a typical scenario. For example, once the operating system loads, a lockscreen for accessing the device may be required. Accordingly, the device may provide more convenient passcode challenges to secure the device by coordinating between multiple software levels. For example, a boot module may provide the software and/or firmware for steps 404-412, while an operating system may provide the lockscreen challenge to access the device of 415.

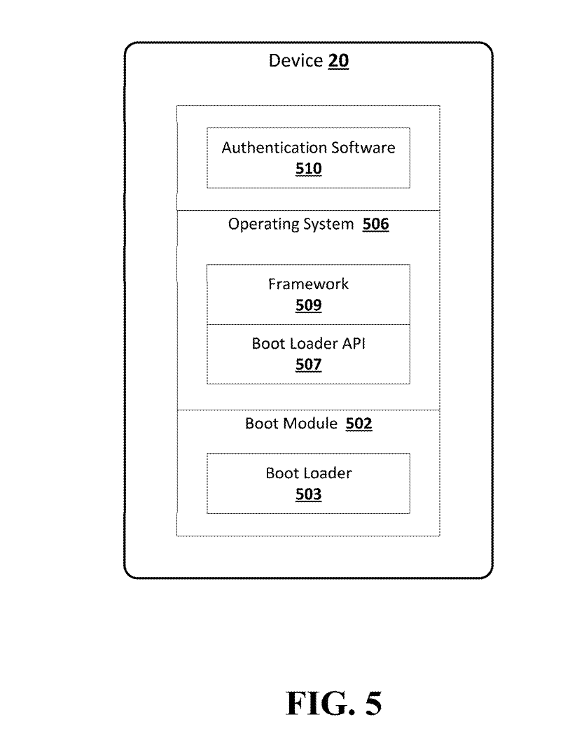

FIG. 5 illustrates an example software hierarchy installed on the device according to an implementation of the disclosed subject matter. As shown, a device may include multiple hierarchal levels of software. In the example shown in FIG. 5, the device may include as the lowest level of software a boot module 502 including a boot loader 503. The device may also include an operating system 506 including a framework 509 and a boot loader API 507. For example, the framework 509 may provide a standard set of libraries in order to perform functions and/or interact with the device. As described above, the API 507 may provide a method of coordinating between boot module 502 and the operating system 506. For example, the boot module 502 may interact with the API 507 to synchronize passcode challenges. The device may also include authentication software 510 for authenticating a user. For example, the authentication software may associate the device with a particular user (e.g. via the device management portal 38).

Various implementations may include or be embodied in the form of computer-implemented process and an apparatus for practicing that process. Implementations may also be embodied in the form of a computer-readable storage containing instructions embodied in non-transitory and/or tangible memory and/or storage, wherein, when the instructions are loaded into and executed by a computer (or processor), the computer becomes an apparatus for practicing implementations of the disclosed subject matter.

The flow diagrams described herein are included as examples. There may be variations to these diagrams or the steps (or operations) described therein without departing from the implementations described herein. For instance, the steps may be performed in parallel, simultaneously, a differing order, or steps may be added, deleted, or modified. Similarly, the block diagrams described herein are included as examples. These configurations are not exhaustive of all the components and there may be variations to these diagrams. Other arrangements and components may be used without departing from the implementations described herein. For instance, components may be added, omitted, and may interact in various ways known to an ordinary person skilled in the art.

References to “one implementation,” “an implementation,” “an example implementation,” and the like, indicate that the implementation described may include a particular feature, structure, or characteristic, but every implementation may not necessarily include the particular step, feature, structure, or characteristic. Moreover, such phrases are not necessarily referring to the same implementation. Further, when a particular step, feature, structure, or characteristic is described in connection with an implementation, such step, feature, structure, or characteristic may be included in other implementations whether or not explicitly described. The term “substantially” may be used herein in association with a claim recitation and may be interpreted as “as nearly as practicable,” “within technical limitations,” and the like.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A device, comprising:
a processor, the processor configured to:
establish, by an operating system of the device, a first passcode challenge for accessing the device;
receive, by a boot module of the device and prior to loading the operating system, an indication to reset the device;
access, by the boot module, the operating system to coordinate a second passcode challenge with the first passcode challenge;
provide, by the boot module, the coordinated second passcode challenge for resetting the device to factory settings; and
reset the device upon a verification of a response to the second passcode challenge.

2. The device of claim 1, wherein said access the operating system to coordinate a second passcode challenge with the first passcode challenge comprises synchronizing the second passcode challenge with the first passcode challenge.

3. The device of claim 1, wherein said access the operating system to coordinate a second passcode challenge with the first passcode challenge comprises accessing an application programming interface (API) of the operating system.

4. The device of claim 1, wherein said access the operating system to coordinate a second passcode challenge with the first passcode challenge comprises accessing a secure storage administered by the operating system.

5. The device of claim 1, wherein the boot module of the device is installed on the device by an original equipment manufacturer (OEM) of the device.

6. The device of claim 5, wherein the operating system is installed on the device by a platform provider distinct from the original equipment manufacturer (OEM).

7. The device of claim 1, wherein said reset the device upon a verification of an inputted passcode in response to the second passcode challenge comprises resetting the device to factory settings.

8. A method, comprising:
establishing, by an operating system of the device, a first passcode challenge for accessing the device;
receiving, by a boot module of the device and prior to loading the operating system, an indication to reset the device;
accessing, by the boot module, the operating system to coordinate a second passcode challenge with the first passcode challenge;
providing, by the boot module, the coordinated second passcode challenge for resetting the device to factory settings; and
resetting the device upon a verification of a response to the second passcode challenge.

9. The method of claim 7, wherein said accessing the operating system to coordinate a second passcode challenge with the first passcode challenge comprises synchronizing the second passcode challenge with the first passcode challenge.

10. The method of claim 7, wherein said accessing the operating system to coordinate a second passcode challenge with the first passcode challenge comprises accessing an application programming interface (API) of the operating system.

11. The method of claim 7, wherein said accessing the operating system to coordinate a second passcode challenge with the first passcode challenge comprises accessing a secure storage administered by the operating system.

12. The method of claim 7, wherein the boot module of the device is installed on the device by an original equipment manufacturer (OEM) of the device.

13. The method of claim 12, wherein the operating system is installed on the device by a platform provider distinct from the original equipment manufacturer (OEM).

14. The method of claim 7, wherein said resetting the device upon a verification of an inputted passcode in response to the second passcode challenge comprises resetting the device to factory settings.

15. A device, comprising:
a processor, the processor configured to:
establish, by an operating system of the device, a first authentication challenge for accessing the device;
receive, by a boot module of the device and prior to loading the operating system, an indication to reset the device;
access, by the boot module, the operating system to coordinate a second authentication challenge with the first authentication challenge;
provide, by the boot module, the coordinated second authentication challenge for resetting the device to factory settings; and
reset the device upon a verification of a response to the second authentication challenge.

16. The device of claim 15, wherein said establish the first authentication challenge for accessing the device comprises establishing a passcode challenge for accessing the device.

17. The device of claim 15, wherein said access the operating system to coordinate a second authentication challenge with the first authentication challenge comprises accessing an application programming interface (API) of the operating system.

18. The device of claim 15, wherein said access the operating system to coordinate a second authentication challenge with the first authentication challenge comprises accessing a secure storage administered by the operating system.

19. The device of claim 15, wherein the boot module of the device is installed on the device by an original equipment manufacturer (OEM) of the device.

20. The device of claim 19, wherein the operating system is installed on the device by a platform provider distinct from the original equipment manufacturer (OEM).
